(19) United States
(12) Patent Application Publication
(10) Pub. No.: US 2018/0081326 A1
(43) Pub. Date: Mar. 22, 2018

(54) APPARATUS AND CONTROL METHOD FOR APPARATUS

(71) Applicant: CANON KABUSHIKI KAISHA, Tokyo (JP)

(72) Inventor: Yasusaburo Degura, Tokyo (JP)

(21) Appl. No.: 15/701,081

(22) Filed: Sep. 11, 2017

(30) Foreign Application Priority Data
Sep. 16, 2016 (JP) 2016-181936

(51) Int. Cl. G05B 11/01; H02J 7/00

(52) U.S. Cl. CPC G05B 11/01; H01R 24/64; H02J 7/0052

(57) ABSTRACT

An apparatus includes an interface unit having a first terminal configured to determine whether an external apparatus is connected to the interface unit and a second terminal configured to receive power from the external apparatus, a detecting unit configured to detect whether the external apparatus and the interface unit are connected based on voltage of the first terminal, and a control unit configured to control receiving power from the external apparatus from the external apparatus through the second terminal, wherein in the case that a second timing when voltage of the second terminal is detected is later than a first timing when the voltage of the first terminal is detected, the control unit executes a first control for receiving power and in the case that the second timing is not later than the first timing, the control unit executes a second control for receiving power.

### BACKGROUND OF THE INVENTION

### Field of the Invention

The aspect of the embodiment relates to an apparatus which can operate with electric power from an external apparatus and can charge a battery device attached thereto and a control method for the apparatus.

### Description of the Related Art

USB (Universal Serial Bus) Type-C cables and connectors are standardized based on USB 3.1 standard. It has been known that electric power is received through a USB Type-C cable to operate an electronic apparatus such as a digital camera and is used to charge a battery device attached thereto. A USB Type-C cable detects the power feeding capability of an external apparatus connected thereto from CC (Configuration Channel) terminal voltage to manage electric power to be used.

An apparatus based on conventional USB 2.0 standard or USB Battery Charging standard (hereinafter, called a non-Type-C apparatus) detects the power feeding capability of a connected apparatus by detection of the connected apparatus and enumeration through a D+ terminal and a D− terminal. In other words, different methods are applied for detecting the power feeding capabilities between a Type-C apparatus being an electronic apparatus based on USB Type-C and a non-Type-C apparatus being an electronic apparatus not based on USB Type-C.

Some USB Type-C cables may have a USB Type-C connector at its one end and a non-Type-C USB 2.0 standard A connector at the other end. An electronic apparatus such as a digital camera to which such a USB Type-C cable is connectable may be required to detect whether an external apparatus connected thereto is a USB Type-C apparatus or a non-Type-C apparatus.

According to Japanese Patent Laid-Open No. 2014-56287, a voltage-dividing resistance value connected to a D+ terminal and a D− terminal connected to an external apparatus is detected to detect the power feeding capability of the external apparatus.

### SUMMARY OF THE INVENTION

An apparatus according to one aspect of the embodiments includes an interface unit having a first terminal configured to determine whether an external apparatus is connected to the interface unit and a second terminal configured to receive power from the external apparatus, a detecting unit configured to detect whether the external apparatus and the interface unit are connected based on voltage of the first terminal, and a control unit configured to control receiving power from the external apparatus from the external apparatus through the second terminal, wherein in the case that a second timing when voltage of the second terminal is detected is later than a first timing when the voltage of the first terminal is detected, the control unit executes a first control for receiving power and in the case that the second timing is not later than the first timing, the control unit executes a second control for receiving power.

Further features of the disclosure will become apparent from the following description of exemplary embodiments with reference to the attached drawings.

### BRIEF DESCRIPTION OF THE DRAWINGS

FIGS. 1A and 1B illustrate outer appearances of an image capture apparatus being an exemplary electronic apparatus.

FIG. 2 is a block diagram illustrating an exemplary configuration of the image capture apparatus according to a first embodiment.

FIG. 3 is a flowchart illustrating exemplary control operation processing to be performed by the image capture apparatus according to the first embodiment.

FIG. 4 is a block diagram illustrating an exemplary configuration of an image capture apparatus according to a second embodiment.

FIG. 5 is a flowchart illustrating control operation processing to be performed by the image capture apparatus according to the second embodiment.

### DESCRIPTION OF THE EMBODIMENTS

Embodiments of the disclosure will be described below with reference to drawings. It should be understood, however, that the disclosure is not limited to the following embodiments.

### First Embodiment

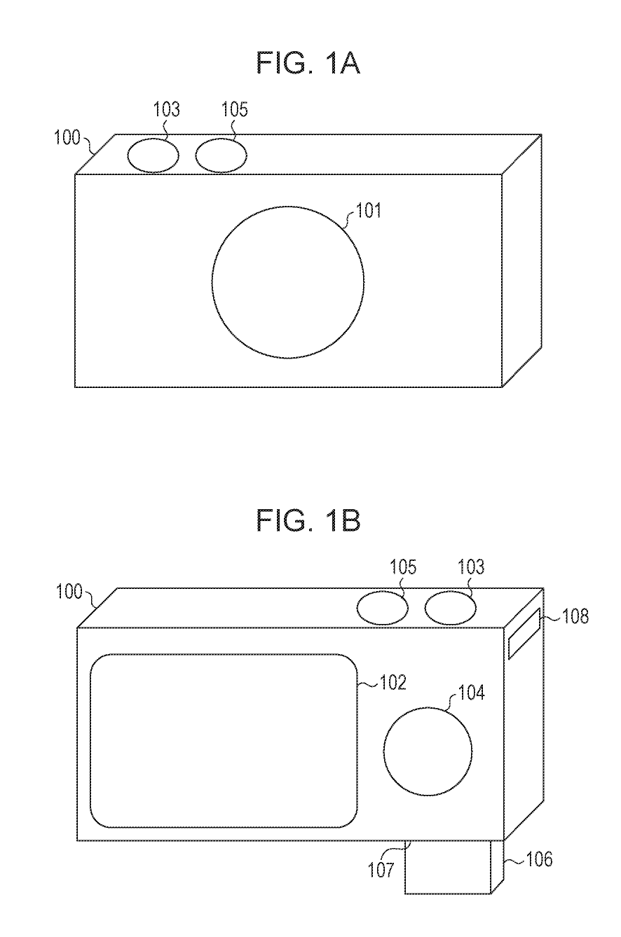

FIGS. 1A and 1B illustrate outer appearances of an image capture apparatus 100 being an exemplary electronic apparatus having a USB Type-C interface. FIG. 1A is a front view of the image capture apparatus 100, and FIG. 1B is a back view of the image capture apparatus 100. The image capture apparatus 100 includes an imaging optical system 101, a display unit 102, a shutter button 103, an operating unit 104, a power switch 105, and a battery connection unit 106. The imaging optical system 101 includes a lens and a shutter and is configured to form a subject image on a photo-receiving surface of an image capture device such as a CCD sensor. The display unit 102 is configured to display an image and information. The display unit 102 may be a liquid crystal display, for example. The shutter button 103 is usable for giving a capture instruction. The operating unit 104 includes operating members such as a switch, a button, and a touch panel for receiving operations performed by a user. The power switch 105 is configured to switch the ON/OFF state of power supply to the image capture apparatus 100. The battery connection unit 106 is connected to a battery device 500 and is configured to receive electric power supplied by the battery device 500. The battery device 500 is a rechargeable battery such as a lithium-ion secondary battery. The image capture apparatus 100 may include the battery device 500. According to the first embodiment, the battery device 500 is a rechargeable battery that is detachably attached to the image capture apparatus 100.

An apparatus connection unit 107 is an interface to an external apparatus and has a terminal 107a configured to receive electric power from an external apparatus connected thereto, a terminal 107b configured to receive power feeding capability information, and a terminal 107c configured to connect to a ground terminal (GND (ground)) of the external apparatus. It is assumed here that the apparatus connection unit 107 is an interface based on USB Type-C standard to which USB Type-C cable is connectable. The terminal 107a of the apparatus connection unit 107 is a VBUS terminal configured to receive VBUS, and the terminal 107b thereof is a CC terminal. The apparatus connection unit 107 further has a terminal 107d (D+ terminal) and a terminal 107e (D− terminal) configured to perform data transmission by using a differential signal.

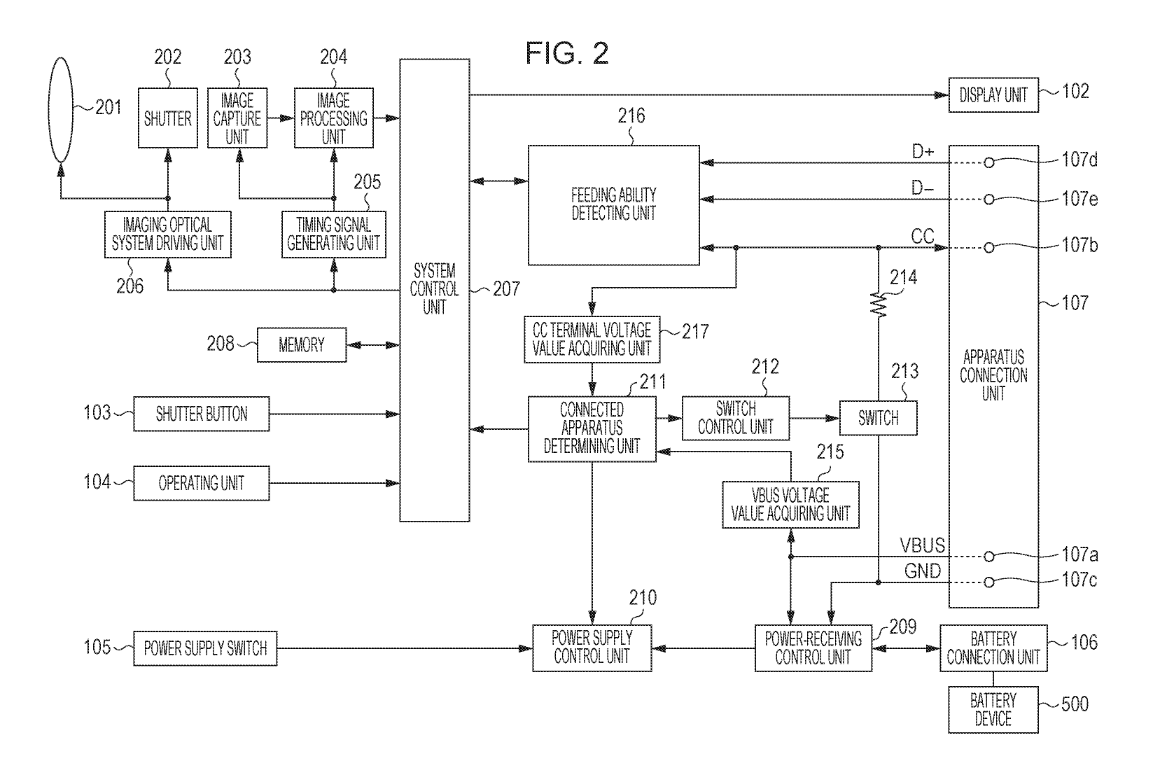

FIG. 2 is a block diagram illustrating an exemplary configuration of the image capture apparatus 100 according to this embodiment. Referring to FIG. 2, a lens unit 201 and a shutter 202 are included in the imaging optical system 101. An image capture unit 203 may have a CCD sensor, for example, and is configured to convert an optical image to an electrical signal. An image processing unit 204 has a correlated double sampling unit, a programmable gain amplifier unit, and an analog digital converter unit and is configured to acquire digital image data from an output signal from the image capture unit 203. The correlated double sampling unit is configured to perform correlated double sampling on an output signal from the image capture unit 203. The programmable gain amplifier unit may be set to a target amplification degree and is configured to amplify an analog signal acquired from the correlated double sampling unit. The analog digital converter unit is configured to convert the amplified analog signal to digital data. A timing signal generating unit 205 is configured to generate signals for causing the image capture unit 203 and the image processing unit 204. An imaging optical system driving unit 206 is configured to cause the lens unit 201 and the shutter 202 to operate.

The system control unit 207 generally controls the image capture apparatus 100. An image signal from the image processing unit 204 is written to the memory 208 through the system control unit 207. The memory 208 stores image data acquired by the image capture unit 203 and converted to the digital data by the image processing unit 204 and image data to be displayed on the display unit 102. The memory 208 has a storage capacity enough for storing a predetermined number of still images and a moving image and audio for a predetermined time period. The memory 208 also functions as a memory (video memory) for image display. The system control unit 207 superimposes predetermined data over data for image display stored in the memory 208 and supplies it to the display unit 102, as required. Thus, image data for display written in the memory 208 is displayed on the display unit 102 which is a display device such as a liquid crystal display.

The shutter button 103 and the operating unit 104 are instruction input members usable for inputting operation instructions to the system control unit 207. In response to a signal generated in the middle of an operation performed on the shutter button 103, that is, a half press (capture preparation instruction) signal, the system control unit 207 starts capture preparation operations such as an AF (auto focus) process, an AE (auto exposure) process, and an AWB (auto white balance) process. In response to an operation completion signal from the shutter button 103, that is, a full press (capture instruction) signal, the system control unit 207 starts a capture processing operation from reading of a signal from the image capture unit 203 to writing of image data to a recording medium such as an SD card.

The power-receiving control unit 209 is configured to supply electric power from the battery device 500 connected to the battery connection unit 106 to the power supply control unit 210. The power-receiving control unit 209 can further supply electric power from an external apparatus received through the VBUS terminal of the apparatus connection unit 107 to the power supply control unit 210. The power-receiving control unit 209 controls the upper limit of electric current fed to the VBUS terminal in a case where electric power is received from the external apparatus through the VBUS terminal. The power-receiving control unit 209 controls the upper limit of electric current fed to the VBUS terminal based on the power feeding capability of an external apparatus detected by the power feeding capability detecting unit 217.

The power-receiving control unit 209 can charge the battery device 500 connected to the battery connection unit 106 with electric power received from the VBUS terminal of the apparatus connection unit 107. The power supply control unit 210 receives electric power supplied from the power-receiving control unit 209 and supplies electric power to components including the system control unit 207 for a required period based on an instruction performed on the power switch 105. The power supply control unit 210 can supply electric power to a connected apparatus determining unit 211, a switch control unit 212, a switch 213, a VBUS voltage value acquiring unit 215, and a CC terminal voltage value acquiring unit 217, which will be described below, independently of an instruction given through the power switch 105.

A resistor 214 is a resistance element having a predetermined resistance value. The resistor 214 is connected between the terminal 107b and the switch 213. The switch 213 is connected between the resistor 214 and a GND+ terminal. The switch 213 can bring the part between the GND+ terminal into a conduction state or a non-conduction state under control of the switch control unit 212. The cooperation of the switch control unit 212 and the switch 213 can implement a function for changing the resistance value of the resistor 214 connected between the CC terminal and the GND+ terminal. More specifically, the resistor 214 having a predetermined resistance value between the CC terminal and the GND+ terminal and the switch 213 which can change to a conduction state or a non-conduction state are serially connected, and the conduction state or non-conduction state of the switch 213 is changed to change the resistance value between the CC terminal and the GND+ terminal. According to this embodiment, the switch 213 initially or without control of the control unit 212 has a conduction state. The VBUS voltage value acquiring unit 215 is configured to acquire voltage value information on the VBUS terminal of the apparatus connection unit 107 and inform it to the connected apparatus determining unit 211.

The CC terminal voltage value acquiring unit 217 is configured to acquire voltage value information corresponding to the voltage of the CC terminal of the apparatus connection unit 107 and inform it to the connected apparatus determining unit 211. The VBUS voltage value acquiring unit 215 is configured to acquire voltage value information corresponding to the voltage (VBUS voltage) of the VBUS terminal of the apparatus connection unit 107 and inform it to the connected apparatus determining unit 211. The connected apparatus determining unit 211 can acquire voltage value information of the VBUS terminal from the VBUS voltage value acquiring unit 215 and voltage value information of the CC terminal from the CC terminal voltage value acquiring unit 217, give a control instruction to the switch control unit 212, instruct to start power supply to components responsible for a predetermined function of the image capture apparatus to the power supply control unit 210, and inform connected apparatus type information to the system control unit 207.

The power feeding capability detecting unit 216 is connected to the CC terminal, the D+ terminal, and the D-terminal of the apparatus connection unit 107. The power feeding capability detecting unit 216 is configured to detect the voltage of the CC terminal, detect an external apparatus connected through the D+ terminal and the D-terminal, and/or detect the power feeding capability of the external apparatus connected to the apparatus connection unit 107 by enumeration. The power feeding capability detecting unit 216 is communicable for communication for USB Power Delivery supported by USB Type-C. The conventional detection of the power feeding capability by using the D+ terminal and the D− terminal is for an electronic apparatus (non-Type-C apparatus) based on a conventional USB standard and does not include identification of the connected external apparatus between a Type-C apparatus and a non-Type-C apparatus. Under USB 3.1 standard, a CC terminal of USB Type-C may be used to detect the power feeding capability of an external apparatus. However, in a case where a non-Type-C apparatus is connected, attempting to detect the power feeding capability by using CC terminal voltage may result in improper detection of the power feeding capability. Then, electric power more than the actual power feeding capability is used, which may cause the apparatus to go down. The disclosure provides an electronic apparatus which can detect whether an external apparatus connected thereto is a Type-C apparatus or a non-Type-C apparatus and a control method therefor.

The power feeding capability detecting unit 216 is configured to receive type information indicating the type of a connected external apparatus from the system control unit 207, detect the power feeding capability of the connected external apparatus based on the type information, and inform it to the system control unit 207. Here, the type information indicates whether the connected external apparatus is a Type-C apparatus or a non-Type-C apparatus. According to the first embodiment, the connected apparatus determining unit 211 is configured to inform the type information regarding a connected external apparatus to the system control unit 207, and the system control unit 207 is configured to inform the type information to the power feeding capability detecting unit 216. However, the connected apparatus determining unit 211 may be configured to inform the type information to the power feeding capability detecting unit 216 without through the system control unit 207. In this case, the power supply control unit 210 supplies electric power to the connected apparatus determining unit 211, the switch control unit 212, the switch 213, the VBUS voltage value acquiring unit 215, the CC terminal voltage value acquiring unit 217, and the power feeding capability detecting unit 216 independently of the an instruction given through the power switch 105.

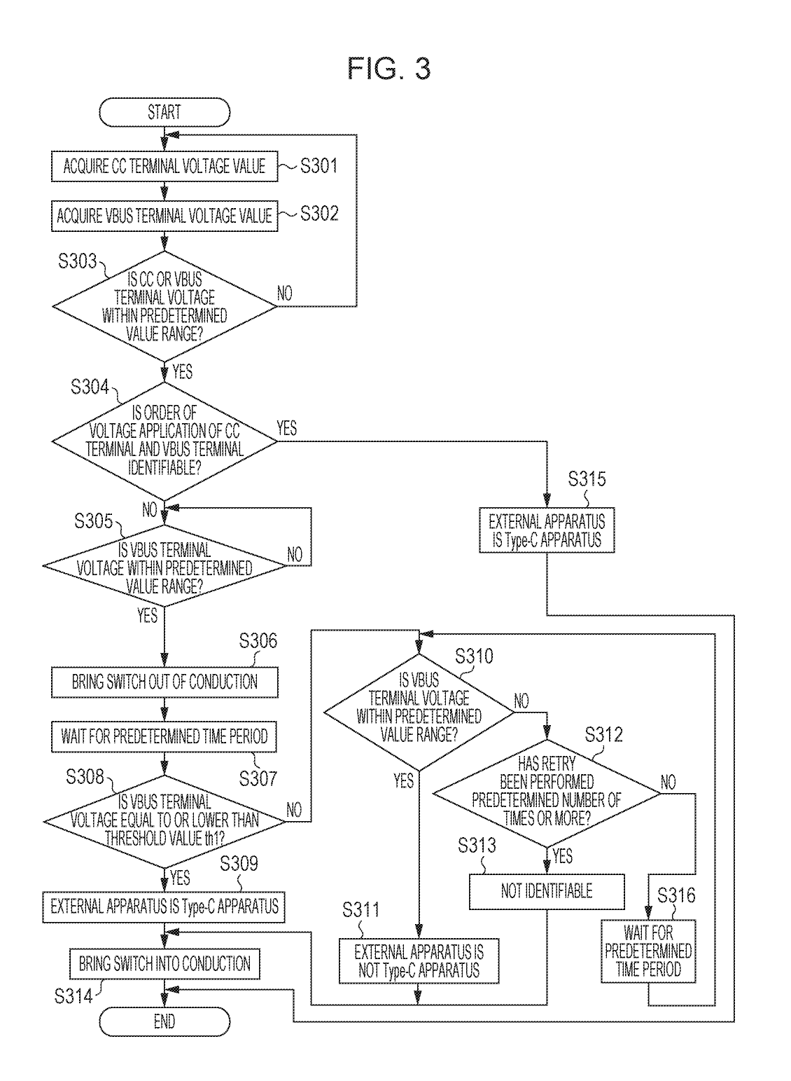

FIG. 3 is a flowchart illustrating exemplary control operations to be performed by the connected apparatus determining unit 211 in a case where an external apparatus is connected to the apparatus connection unit 107 via a USB Type-C cable when the main power supply for the image capture apparatus 100 configured as described above has an OFF state.

The connected apparatus determining unit 211 acquires voltage value information regarding the CC terminal from the CC terminal voltage value acquiring unit 217 (S301) and acquires voltage value information regarding the VBUS terminal from the VBUS voltage value acquiring unit 215 (S302). The connected apparatus determining unit 211 determines whether the CC terminal voltage value and the VBUS terminal voltage value fall within a predetermined range with reference to the voltage value information regarding the CC terminal acquired from the CC terminal voltage value acquiring unit 217 and voltage value information regarding the VBUS terminal acquired from the VBUS voltage value acquiring unit 215 (S303). For example, a predetermined voltage range VR_{CC} for CC terminal voltage values is equal to or higher than 0.25 V and equal to or lower than 2.04 V, and a predetermined voltage range VR_{VBUS} for VBUS terminal voltage values is equal to or higher than 4.75 V and equal to or lower than 5.25 V. In a case where the CC terminal voltage value is within the predetermined range for CC terminal voltage values, the connected apparatus determining unit 211 determines that an external apparatus is connected thereto through the interface (apparatus connection unit 107).

The connected apparatus determining unit 211 stores a clock time (timing) t1 when voltage value information regarding the CC terminal reaches the voltage range VR_{CC} and a clock time (timing) t2 when the voltage value information regarding the VBUS terminal reaches VR_{VBUS} in the memory 208 through the system control unit 207. More specifically, at the time t1, the voltage of the CC terminal out of the voltage range VR_{CC} changes to voltage within the voltage range VR_{CC}. At the time t2, the voltage of the VBUS terminal out of the voltage range VR_{VBUS} changes to voltage within the voltage range VR_{VBUS} The voltage ranges for determining those times are not limited thereto. For example, the voltage range VR_{CC} may be equal to or higher than 0.2 V and equal to or lower than 2.1 V, and the voltage range VR_{VBUS} may be equal to or higher than 4.5 V and equal to or lower than 5.5 V. The clock times t1 and t2 to be acquired by the connected apparatus determining unit 211 are not limited to the clock times as described above. The connected apparatus determining unit 211 may acquire a clock time t1 when the CC terminal voltage value becomes equal to or higher than a predetermined value (threshold value th_CC) after an external apparatus and the electronic apparatus are connected and a clock time t2 when the VBUS terminal voltage value becomes equal to or higher than a predetermined value (threshold value th_VBUS). In this case, the threshold valueth_CC and the threshold valueth_VBUS may be different from predetermined ranges corresponding to the voltage value information regarding the respective terminals.

In a case where both of the CC terminal voltage value and the VBUS terminal voltage value are not within the predetermined ranges (No in S303), the connected apparatus determining unit 211 repeats the processing in and subsequent to S301. In a case where the CC terminal voltage value or the VBUS terminal voltage value falls within the predetermined range (YES in S303), the connected apparatus determining unit 211 determines the order of voltage application between the CC terminal and the VBUS terminal (S304).

In a case where the connected external apparatus is of USB Type-C, output of VBUS voltage is started before t VBUS ON (275 msec) according to USB Type-C standard after the resistance value of the resistor 214 connected between the CC terminal and the GND+ terminal is detected. On the other hand, in a case where the connected external apparatus is of non-Type-C, VBUS voltage is output at all times independently of the resistance value between the CC terminal and the GND+ terminal. Thus, if it is detected that the CC terminal voltage is applied earlier than the VBUS terminal voltage (YES in S304), the connected apparatus determining unit 211 determines that the external apparatus is a USB Type-C apparatus (S315). Then, the processing ends. For example, if the clock time t1 is earlier than the clock time t2 stored in the memory 208, the connected apparatus determining unit 211 determines that the CC terminal voltage has been applied earlier than the VBUS terminal voltage.

If the order of voltage application between the CC terminal and the VBUS terminal is not determined (NO in S304), the connected apparatus determining unit 211 determines whether the VBUS terminal voltage has a value within a predetermined range with reference to voltage value information from the VBUS voltage value acquiring unit 215 (S305). The predetermined range may be equal to or higher than 4.75 V and equal to or lower than 5.25 V, for example. If the VBUS terminal voltage does not have a value within a predetermined range (NO in S305), the connected apparatus determining unit 211 waits until the VBUS terminal voltage has a value within the predetermined range. If the VBUS terminal voltage has a value within the predetermined range (YES in S305), the connected apparatus determining unit 211 determines the type of the external apparatus. In and after S306, according to the first embodiment, the connected apparatus determining unit 211 changes the resistance value between the CC terminal and the GND+ terminal and then determines the type of the external apparatus with reference to the voltage value acquired by the VBUS voltage value acquiring unit 215 after a lapse of a predetermined wait time.

First, the connected apparatus determining unit 211 gives a control instruction to the switch control unit 212 to bring the switch 213 having a conduction state into non-conduction (S306) and wait for a wait time (S307). The switch 213 having a non-conduction state changes the connection state of the CC terminal from a state connected to the GND+ terminal with the resistor 214 having a predetermined resistance value to a non-connected state. The wait time for the waiting in S307 may be equal to 650 msec which is a maximum time period for t VBUS OFF according to USB Type-C standard, for example.

The connected apparatus determining unit 211 after waiting for the predetermined time determines whether the VBUS terminal voltage is equal to or lower than a threshold value th1 with reference to the voltage value information from the VBUS voltage value acquiring unit 215 (S308). If the connected external apparatus is a USB Type-C apparatus, the output of VBUS voltage stops before the end of the maximum time of t VBUS OFF. If the connected apparatus is a non-Type-C apparatus on the other hand, the VBUS voltage is output at all times independently of the resistance value between the CC terminal and the GND+ terminal. In other words, in S308, the connected apparatus determining unit 211 determines whether VBUS voltage equal to or higher than the threshold value th1 is applied to the VBUS terminal from the external apparatus or not independently of the resistance value between the CC terminal and the GND+ terminal. The threshold value th1 may be 1.0 V, for example, in view of the capacitance between the VBUS terminal and the GND+ terminal. During the wait time in S307 before the determination in S308, electric charges stored in the capacitance between the VBUS terminal and the GND+ terminal may be discharged. If the VBUS terminal voltage is equal to or lower than the threshold value th1 (YES in S308), the connected apparatus determining unit 211 determines that the connected external apparatus is a USB Type-C external apparatus (S309).

If the VBUS terminal voltage is not equal to or lower than the threshold value th1 (NO in S308) after the waiting for the predetermined time in S303, the connected apparatus determining unit 211 determines whether the VBUS terminal voltage is within a predetermined range (S310). The predetermined range may be equal to or higher than 4.75 V and equal to or lower than 5.25 V, for example. If the VBUS terminal voltage has a value within the predetermined range (YES in S310), the connected apparatus determining unit 211 determines that the connected external apparatus is a non-Type-C apparatus (S311). If the VBUS terminal voltage does not have a value within the predetermined range (NO in S310), the connected apparatus determining unit 211 retries the determination in S310 up to a predetermined number of times (until a time when NO is determined in S312). In the retry, after waiting for a predetermined wait time (S316), the connected apparatus determining unit 211 determines whether the VBUS terminal voltage has a value within a predetermined range or not. The wait time in S316 and the predetermined number of times in S312 may be set such that unnecessary time is not to be taken for the determination. For example, in order to complete the determination in 1 second (1000 ms), the wait time may be set to 50 ms and the predetermined number of times may be set to six. Thus, the determination process may be completed in approximately 900 ms including the wait time (650 ms) in S307.

If the VBUS terminal voltage does not have a value within the predetermined range even after the predetermined number of retry (YES in S312), the connected apparatus determining unit 211 determines that the type of the connected external apparatus is not identifiable (S313). The connected apparatus determining unit 211 after obtaining a determination result regarding the type of the external apparatus by performing the processing in one of S309, S311, and S313 gives a control instruction to the switch control unit 212 to return the switch 213 brought into a non-conduction state in S306 to a conduction state (S314) and completes the control operation. In a case where the time t2 is not detected even after a lapse of a predetermined period after the time t1 without performing the processing in and subsequent to S305, it may be determined that the external apparatus is a non-Type-C apparatus.

Through the control operation as described above, the connected apparatus determining unit 211 can identify the type of the external apparatus (connected apparatus) connected to the image capture apparatus 100 (electronic apparatus). The connected apparatus determining unit 211 may instruct the power supply control unit 210 to start power supply to the system control unit 207 and the power feeding capability detecting unit 216, for example. The connected apparatus determining unit 211 informs the type information indicating the type determined in S309, S311, or S315 to the system control unit 207, and the system control unit 207 then informs the type information to the power feeding capability detecting unit 216. Alternatively, the connected apparatus determining unit 211 may store type information in a predetermined memory, and after the power supply control unit 210 supplies power to the components including the system control unit 207, the system control unit 207 may acquire the type information from the predetermined memory. The power supply control unit 210 supplies power to the components based on an instruction given through the power switch 105. The power feeding capability detecting unit 216 can appropriately detect the power feeding capability of the external apparatus based on the informed type information.

These control operations may be performed before the power feeding capability detecting unit 216 performs USB Power Delivery communication supported by USB Type-C. If it is determined in S309 or S315 that the connected external apparatus is a Type-C apparatus, the power feeding capability of the connected external apparatus is detected from voltage information from the CC terminal or data transmission from the CC terminal. More specifically, the power feeding capability detecting unit 216 detects an upper limit of current value with which the external apparatus can feed electric power. On the other hand, if it is determined in S311 that the connected external apparatus is a non-Type-C apparatus, the connected apparatus is detected by using the D+ terminal and the D− terminal, and/or the power feeding capability of the external apparatus is detected by enumeration using the D+ terminal and the D− terminal.

The power-receiving control unit 209 sets an upper limit of current value of the VBUS terminal based on the power feeding capability of the external apparatus detected by the power feeding capability detecting unit 216 and controls power receiving from the external apparatus. For example, if the external apparatus is a Type-C apparatus, the power-receiving control unit 209 executes power-receiving control including setting an upper limit of current value based on the voltage value of the CC terminal. If the external apparatus is not a Type-C apparatus, the power-receiving control unit 209 executes power-receiving control including setting an upper limit of current value based on the voltage values of the D+ terminal and the D-terminal or a result of the enumeration (communication) using the D+ terminal and the D− terminal. If the external apparatus is not a Type-C apparatus, the power-receiving control unit 209 may control to stop power receiving from the external apparatus through the VBUS terminal.

Having described a case where the main power supply of the image capture apparatus 100 has an OFF state according to the first embodiment, the control operations as described above may be performed even when the main power supply of the image capture apparatus 100 has an ON state. If the system control unit 207 is informed by the connected apparatus determining unit 211 the type information indicating that the type of the external apparatus is not identifiable, a control may be performed not to use electric power from the external apparatus, for example. Alternatively, the system control unit 207 may instruct the power feeding capability detecting unit 216 to check the power feeding capability of the external apparatus by performing communication using the CC terminal or the D+ terminal and the D− terminal. This embodiment is not limited to a control operation to be performed in a case where the system control unit 207 obtains the information indicating that the type of the external apparatus is not identifiable.

The image capture apparatus 100 according to the first embodiment can detect whether the connected external apparatus is a Type-C apparatus or a non-Type-C apparatus. Thus, the image capture apparatus 100 can correctly identify and manage electric power usable by the connected external apparatus. This enables secure execution of operations based on the power feeding capability of the external apparatus and charging of a battery device based on the power feeding capability of the external apparatus. This can further prevent wrong determination of the power feeding capability of the external apparatus and use of electric power more than the actual power feeding capability, which causes the apparatus to go down. Having described the image capture apparatus as an example of the electronic apparatus according to this exemplary embodiment, embodiments of the disclosure are not limited thereto. Embodiments of the disclosure are applicable to any electronic apparatus if it has a USB Type-C interface.

### Second Embodiment

Next, a second embodiment will be described. According to the first embodiment, electric power for operating the connected apparatus determining unit 211, the switch control unit 212, the switch 213, the VBUS voltage value acquiring unit 215, and the CC terminal voltage value acquiring unit 217 is supplied from the battery device 500 connected to the battery connection unit 106. When the battery device 500 stores a low amount of power or when the battery device 500 is not connected, the control operations as illustrated in FIG. 3 may not be performed. Accordingly, an electronic apparatus according to the second embodiment enables to execute the control operations illustrated in FIG. 3 even when the battery device 500 stores a low amount of power or when the battery device 500 is not connected. Also according to the second embodiment, the image capture apparatus 100 having a configuration similar to that of the first embodiment is illustrated as an example of the electronic apparatus. The image capture apparatus 100 according to the second embodiment also has the same outer appearance as that of the first exemplary embodiment (FIGS. 1A and 1B).

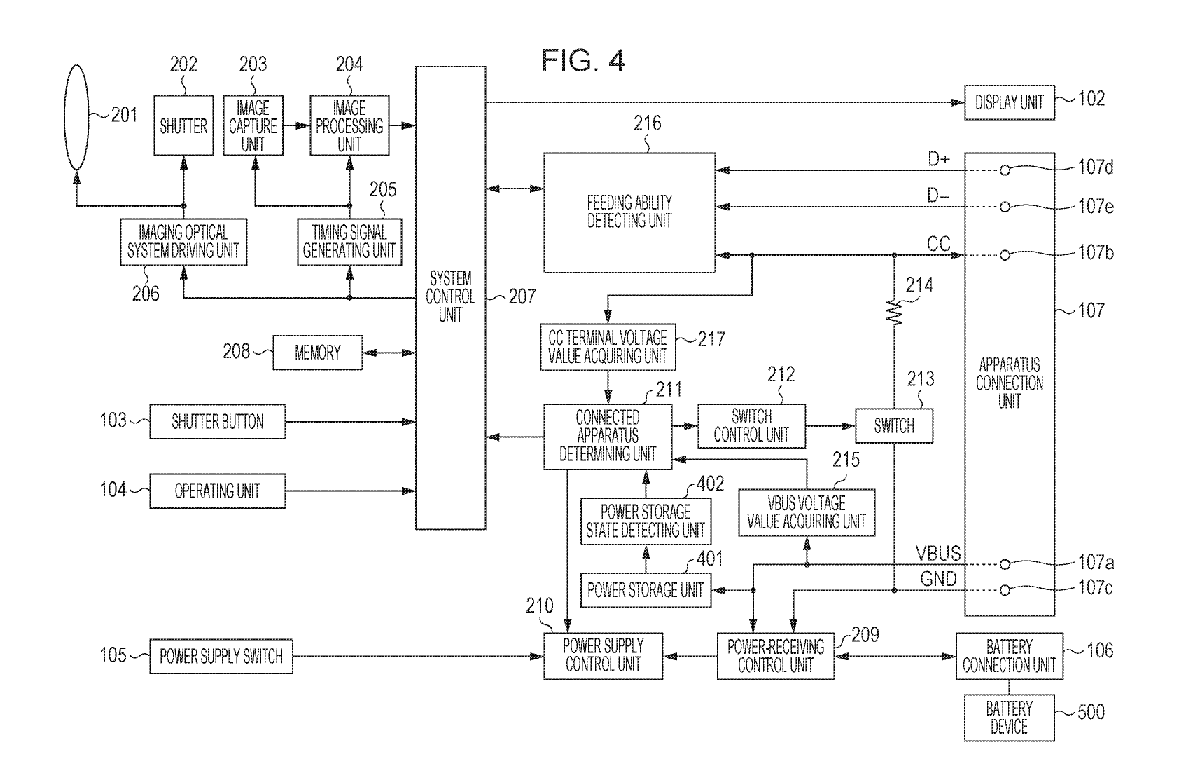

FIG. 4 is a block diagram illustrating an example of the configuration of the image capture apparatus 100 according to the second embodiment. Like numbers refer to like parts through the first embodiment (FIG. 2) and the second embodiment. Referring to FIG. 4, the power storage unit 401 may include, for example, a regulator configured to receive VBUS voltage and output 3.3 V and a 4.7 μF capacitor to be charged with the regulator output. In this case, when, for example, charging electric current is equal to 1 mA, 15.5 μC electric charges are stored in the capacitor in 15.5 msec. The power storage unit 401 uses the stored electric charges to supply electric power for operating the connected apparatus determining unit 211, the switch control unit 212, the switch 213, the VBUS voltage value acquiring unit 215, the CC terminal voltage value acquiring unit 217, and the power storage state detecting unit 402. For example, when input power source voltage for operating components receiving electric power supplied from the power storage unit 401 is within a range of 3.3 V to 1.8 V and when the total electric current consumption is equal to 5 μA, the apparatus can operated in approximately 1400 msec ((15.5 μC−(4.7 μF×1.8 V))/5 μA≈1400 ms). The power storage state detecting unit 402 detects the power storage state of the power storage unit 401 based on the voltage value of the power storage unit 401, for example, and informs acquired information to the connected apparatus determining unit 211.

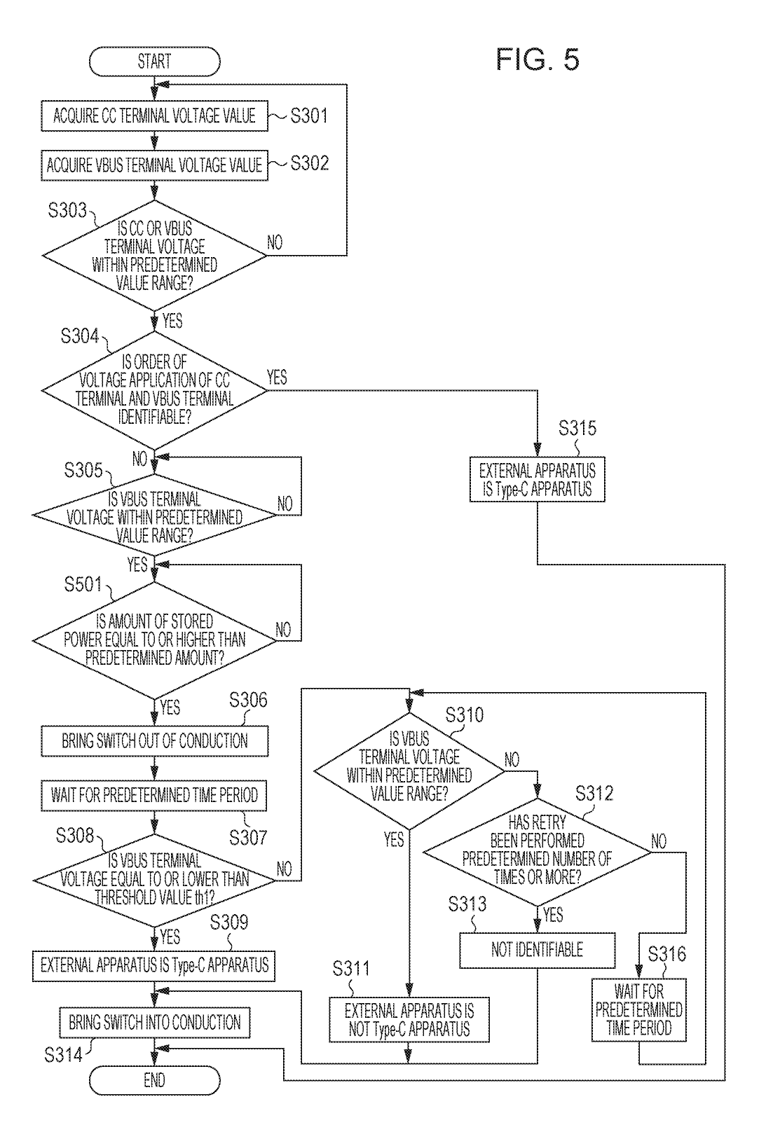

FIG. 5 is a flowchart illustrating exemplary control operations to be performed by the connected apparatus determining unit 211 when the main power supply of the image capture apparatus 100 according to the second embodiment having the configuration as described above has an OFF state and in a case where an external apparatus is connected to the apparatus connection unit 107 through a USB Type-C cable.

Referring to FIG. 5, the operations in S301 to S305 are the same as those of the first embodiment. The connected apparatus determining unit 211 starting to operate with electric power supplied from the power storage unit 401 acquires voltage value information of the CC terminal from the CC terminal voltage value acquiring unit 217 (S301) and acquires voltage value information of the VBUS terminal from the VBUS voltage value acquiring unit 215 (S302). The connected apparatus determining unit 211 determines whether the values acquired by the CC terminal voltage value acquiring unit 217 and the VBUS voltage value acquiring unit 215 fall within a predetermined range (S303). The predetermined range may be equal to or higher than 0.25 V and equal to or lower than 2.04 V for the CC terminal voltage value and equal to or higher than 4.75 V and equal to or lower than 5.25 V for the VBUS terminal voltage value, for example.

In a case where both of the CC terminal voltage value and the VBUS terminal voltage value are not within the predetermined ranges (No in S303), the connected apparatus determining unit 211 repeats the processing in and subsequent to S301. In a case where the CC terminal voltage value or the VBUS terminal voltage value falls within the predetermined range (YES in S303), the connected apparatus determining unit 211 determines the order of voltage application between the CC terminal and the VBUS terminal (S304). Thus, if it is detected that the CC terminal voltage is applied earlier than the VBUS terminal voltage (YES in S304), the connected apparatus determining unit 211 determines that the connected external apparatus is a USB Type-C apparatus (S315). Then, the processing ends.

If the order of voltage application between the CC terminal and the VBUS terminal is not determined (NO in S304), the connected apparatus determining unit 211 determines whether the VBUS terminal voltage has a value within a predetermined range with reference to voltage value information from the VBUS voltage value acquiring unit 215 (S305). If the VBUS terminal voltage is within the predetermined value (YES in S305), the connected apparatus determining unit 211 refers to the power storage state detecting unit 402 to check whether the amount of stored power in the power storage unit 401 is equal to or higher than a predetermined amount of stored power (S501). It is assumed here, for example, that the predetermined amount of stored power is equal to an amount of stored power for supplying electric power to enable the connected apparatus determining unit 211 to function from the time when the switch control unit 212 changes the state of the switch 213 to the time when the connected apparatus determining unit 211 determines the type of the external apparatus. For example, the amount may be equal to 14 μC which is about 90% of 15.5 μC described above. In this case, under the conditions as described above, the apparatus can operate for approximately 1100 ms (((14 μC−(4.7 μF×1.8 V))/5 μA≈1100 ms)).

If the amount of stored power in the power storage unit 401 is not equal to or higher than the predetermined amount of stored power (NO in S501), the connected apparatus determining unit 211 waits until the amount of stored power in the power storage unit 401 reaches the predetermined amount of stored power (14 μC) or higher. If the amount of stored power in the power storage unit 401 is equal to or higher than the predetermined amount of stored power (YES in S501), a control instruction is given to the switch control unit 212 to bring the switch 213 having a conduction state into a non-conduction state (S306) and to wait for a predetermined time period (S307). The subsequent control operations are the same as those of the processing (in S308 to S313, S316) illustrated in FIG. 3. However, the number of times of retry if NO in S310 and the wait time S316 are to be set such that the process can be completed within the time period (within 1100 ms under the conditions) during which the apparatus can operate with power fed from the power storage unit 401. As illustrated according to the first embodiment, the wait time may be set to 50 ms and the predetermined number of times may be set to six so that the determination process may be completed in approximately 900 ms. Thus, the determination process can be completed within the 1100 ms operation time.

Bringing the switch 213 into non-conduction in S306 changes the state of the CC terminal connected to the GND+ terminal with the resistor 214 having a predetermined resistance value to a non-connected state. If the connected external apparatus is a Type-C apparatus, the output of VBUS voltage stops before the end of the maximum time Period (650 ms) of t VBUS OFF. At this point in time, the connected apparatus determining unit 211, the switch control unit 212, the switch 213, the VBUS voltage value acquiring unit 215, the CC terminal voltage value acquiring unit 217, and power storage state detecting unit 402 may stop operating if electric power for operating them is supplied from the VBUS of the external apparatus. Accordingly, the connected apparatus determining unit 211 checks in S501 whether the power storage unit 401 stores electric charges enough for supplying electric power to be used for the operations at least from S306 where the switch 213 is brought into a non-conduction state to S314 where the switch 213 is brought into a conduction state.

It is not intended that the power storage unit 401 is limited to the configuration as described above if it can supply the electric power. Having described that the power storage unit 401 includes a regulator configured to receive VBUS voltage and output 3.3 V and a 4.7 μF capacitor to be charged with the regulator output, the capacitor may be directly charged with VBUS voltage, for example. The capacitor of the power storage unit 401 may be a capacitance which can store electric charges enough for supplying electric power to be used for the operations at least from S302 where the switch 213 is brought into a non-conduction state to S310 where the switch 213 is brought into a conduction state and is not limited to have the aforementioned capacitance. Instead of the capacitor in the power storage unit 401, devices which can store electric charges excluding a capacitor, such as a secondary battery, may be used. Therefore, the battery device 500 connected to the battery connection unit 106 may be used as the capacitor for the power storage unit 401. According to the second embodiment, it is not intended to limit the configuration of the power storage unit 401.

The image capture apparatus 100 according to second embodiment can detect the type of the connected external apparatus, that is, whether the connected external apparatus is a Type-C apparatus or a non-Type-C apparatus even when the amount of stored power in the battery device 500 is low or the battery device 500 is not connected. Thus, whether the external apparatus is a Type-C apparatus or a non-Type-C apparatus can be detected independently of the power in the battery device so that the electric power to be used can be properly managed. As a result, operations based on the power feeding capability of the external apparatus can be performed, and the attached battery device can be charged. This can further prevent wrong determination of the power feeding capability of the external apparatus and use of electric power more than the actual power feeding capability, which causes the apparatus to go down.

According to the first and second embodiments, the processing illustrated in FIGS. 3 and 5 are performed based on connection of an external apparatus when the main power supply to the image capture apparatus 100 is OFF. However, the same control operations may be performed even when the main power supply to the image capture apparatus 100 is ON.

According to the aforementioned embodiments, the type of the connected external apparatus, that is, whether the connected external apparatus is a Type-C apparatus or a non-Type-C apparatus can be detected. Particularly according to the second embodiment, the type can be detected independently of the power in an installed battery device so that electric power to be used can be properly managed. Thus, an electronic apparatus and a control method for the electronic apparatus can be provided which can prevent wrong determination of the power feeding capability of the connected apparatus and use of electric power more than the actual power feeding capability, which causes the apparatus to go down.

Having described embodiments of the disclosure, the disclosure is not limited to the aforementioned embodiments, and various deformation and changes can be made thereto without departing from the spirit and scope of the disclosure.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-181936 filed Sep. 16, 2016, which is hereby incorporated by reference herein in its entirety.

What is claimed is:

1. An apparatus comprising:
an interface unit having a first terminal configured to determine whether an external apparatus is connected to the interface unit and a second terminal configured to receive power from the external apparatus;
a detecting unit configured to detect whether the external apparatus and the interface unit are connected based on voltage of the first terminal; and
a control unit configured to control receiving power from the external apparatus from the external apparatus through the second terminal,
wherein
in the case that a second timing when voltage of the second terminal is detected is later than a first timing when the voltage of the first terminal is detected, the control unit executes a first control for receiving power and
in the case that the second timing is not later than the first timing, the control unit executes a second control for receiving power.

2. The apparatus according to claim 1, wherein
the detecting unit detects that the external apparatus and the interface unit are connected in a case where the voltage of the first terminal call within a first voltage range,
the first timing is a timing when the voltage of the first terminal changes from a voltage off the first voltage range to a voltage within the first voltage range, and
the second timing is a timing when the voltage of the second terminal changes from a voltage off a second voltage range to a voltage within the second voltage range.

3. The apparatus according to claim 2, wherein
the interface unit is an interface based on USB Type-C standard,
the first terminal is a CC terminal,
the second terminal is a VBUS terminal,
the first voltage range is equal to or higher than 0.2 V and equal to or lower than 2.1 V, and
the second voltage range is equal to or higher than 4.75 V and equal to or lower than 5.25 V.

4. The apparatus according to claim 1,
wherein the control unit controls power receiving from the external apparatus through the second terminal under the first control by assuming that a current value based on the voltage of the first terminal is an upper limit of a current value fed to the second terminal.

5. The apparatus according to claim 1, further comprising:
a third terminal and a fourth terminal for connection to the external apparatus,
wherein the control unit controls power receiving from the external apparatus through the second terminal under the second control by assuming that a current value based on the voltage values of the third terminal and the fourth terminal is an upper limit of a current value fed to the second terminal.

6. The apparatus according to claim 1, further comprising:
a third terminal and a fourth terminal for connection to the external apparatus,
wherein the control unit controls power receiving from the external apparatus through the second terminal under the second control by assuming that a current value based on a result of communication with the external apparatus through the third terminal and the fourth terminal is an upper limit of a current value fed to the second terminal.

7. The apparatus according to claim 1,
wherein the control unit controls not to receive power from the external apparatus through the second terminal under the second control.

8. The apparatus according to claim 1, wherein
the interface unit is an interface based on USB Type-C standard,
the first terminal is a CC terminal, and
the second terminal is a VBUS terminal.

9. The apparatus according to claim 1,
wherein the control unit controls power receiving from the external apparatus through the second terminal under the second control in a case where a delay time for the second timing with respect to the first timing is longer than a predetermined length.

10. The apparatus according to claim 1, further comprising:
a third terminal configured to connect to a ground terminal of the external apparatus; and
a changing unit configured to change a resistance value between the second terminal and the third terminal,
wherein, in a case where the control unit does not detect that the second timing is later than the first timing,
the changing unit changes the resistance value, and
the control unit determines the type of the external apparatus based on the voltage of the first terminal after the changing unit changes the resistance value.

11. An apparatus comprising:
an interface unit having a first terminal configured to determine whether an external apparatus is connected to the interface unit and a second terminal configured to receive power from the external apparatus;
a connection detecting unit configured to detect whether the external apparatus and the interface unit are connected based on voltage of the first terminal; and
a determination unit configured to determine a type of the external apparatus based on the order of a first timing when the voltage of the first terminal is detected and a second timing when the voltage of the second terminal is detected.

12. The apparatus according to claim 11, further comprising:
a detecting unit configured to detect the power feeding capability of the external apparatus by applying a detection method based on the determined type of the external apparatus.

13. The apparatus according to claim 11,
wherein the determination unit determines that the external apparatus is an apparatus based on USB-Type-C standard in a case where the voltage of the first terminal is changed to a predetermined value or higher earlier than a change of voltage of the second terminal to a predetermined value or higher after the external apparatus and the apparatus are connected.

14. The apparatus according to claim 11,
wherein the determination unit determines that the external apparatus is not an apparatus based on USB Type-C in a case where start of application of voltage to the first terminal is detected after application of voltage to the second terminal is detected.

15. A method for an apparatus having an interface unit having a first terminal configured to determine whether an external apparatus is connected to the interface unit and a second terminal configured to receive power from the external apparatus, the method comprising:
detecting whether the external apparatus and the interface unit are connected based on voltage of the first terminal; and
controlling receiving power from the external apparatus from the external apparatus through the second terminal,
wherein
in the case that a second timing when voltage of the second terminal is detected is later than a first timing when the voltage of the first terminal is detected, the controlling executes a first control for receiving power and
in the case that the second timing is not later than the first timing, the controlling executes a second control for receiving power.

16. The method according to claim 15,
wherein
the detecting detects that the external apparatus and the interface unit are connected in a case where the voltage of the first terminal call within a first voltage range,
the first timing is a timing when the voltage of the first terminal changes from a voltage off the first voltage range to a voltage within the first voltage range, and
the second timing is a timing when the voltage of the second terminal changes from a voltage off a second voltage range to a voltage within the second voltage range.

17. The method according to claim 15,
wherein the controlling controls power receiving from the external apparatus through the second terminal under the first control by assuming that a current value based on the voltage of the first terminal is an upper limit of a current value fed to the second terminal.

18. A method for an apparatus having an interface unit having a first terminal configured to determine whether an external apparatus is connected to the interface unit and a second terminal configured to receive power from the external apparatus, the method comprising:
detecting whether the external apparatus and the interface unit are connected based on voltage of the first terminal; and
determining a type of the external apparatus based on the order of a first timing when the voltage of the first terminal is detected and a second timing when the voltage of the second terminal is detected.

19. The method according to claim 18, further comprising:
detecting the power feeding capability of the external apparatus by applying a detection method based on the determined type of the external apparatus.

20. The method according to claim 18,
wherein the determining determines that the external apparatus is an apparatus based on USB-Type-C standard in a case where the voltage of the first terminal is changed to a predetermined value or higher earlier than a change of voltage of the second terminal to a predetermined value or higher after the external apparatus and the apparatus are connected.
